(19) United States
(12) Patent Application Publication
(10) Pub. No.: US 2009/0121047 A1
(43) Pub. Date: May 14, 2009

(54) FAN SPRAY DEVICE

(75) Inventor: Victor Ptak, Plymouth, MI (US)

Correspondence Address: BROOKS KUSHMAN P.C., 1000 TOWN CENTER, TWENTY-SECOND FLOOR, SOUTHFIELD, MI, 48075, US

(73) Assignee: Stylus, Inc., Southfield, MI (US)

(21) Appl. No.: 12/211,921

(22) Filed: Sep. 17, 2008

Related U.S. Application Data
(63) Continuation of application No. 11/939,714, filed on Nov. 14, 2007, now abandoned.

(51) Int. Cl. B05B 11/00

(52) U.S. Cl. 239/289

(57) ABSTRACT

A fan spray device is provided with a housing defining a liquid reservoir, a port providing access to the liquid reservoir, and a handle portion. A fan assembly is provided on the housing. A spray assembly, proximate the fan assembly, dispenses liquid from the liquid reservoir. A character head, mounted on the housing, is spaced apart from the port. Also, a fan spray device having a housing is provided. The housing has base and handle portions, a front portion spaced apart from the handle portion, and an upper portion connecting the front and handle portions. A liquid reservoir is disposed within the handle portion. The upper portion has a port in fluid communication with the liquid reservoir to receive liquid therethrough to store in the liquid reservoir. A fan assembly is mounted on the front portion. A spray assembly is provided to dispense liquid from the liquid reservoir.

### CROSS-REFERENCE TO RELATED APPLICATIONS

This application is a Continuation of U.S. application Ser. No. 11/939,714 filed Nov. 14, 2007.

### BACKGROUND

1. Technical Field

The invention relates to a fan spray device.

2. Background Art

A hand held spray device typically stores liquid to dispense the liquid upon actuation of a trigger. Actuation of the trigger of the spray device produces a liquid stream and/or a liquid mist from a nozzle of the spray device. Liquid streams and/or mists are often used when dispensing liquid in order to cool a user when sprayed upon a face or body of the user.

A hand held fan device generally utilizes battery power to provide air movement as desired by a user. The fan device is typically mounted on the spray device to produce a fan spray device. The fan of the fan spray device facilitates additional cooling of the user through air movement and further misting of the liquid dispensed upon actuation of the trigger. The fan can be actuated by the trigger or can have actuation separate from the trigger.

The spray device, the fan device and the fan spray device are popular in order to cool users when the users are spending a large amount of time outdoors. Environments where the spray device, the fan device and the fan spray device are popular are amusement parks or theme parks where users often spend long periods of time in a hot summer climate strolling, socializing and/or waiting in an outdoor thoroughfare.

The prior art has offered a novelty character head mounted upon a spray device to increase the aesthetics of the spray device. Novelty character heads can have the shape of an animal character, a cartoon character or other novelty shape, which may be attractive to potential users, such as children. A nozzle of the spray device is positioned in a mouth area of the character head.

### SUMMARY

In one embodiment, a fan spray device is provided with a housing defining a liquid reservoir and a port providing access to the liquid reservoir. The housing has a handle portion. A fan assembly is provided on the housing. A spray assembly is provided proximate the fan assembly to dispense liquid from the liquid reservoir of the housing. A character head is mounted on the housing and spaced apart from the port such that liquid can be received through the port without removing the character head.

In another embodiment, a fan spray device having a housing is disclosed. The housing has a base portion, a handle portion, a front portion extending from the base portion and spaced apart from the handle portion, an upper portion connecting the front portion and the handle portion, and a liquid reservoir disposed within the handle portion. The upper portion has a port therein a port therein in fluid communication with the liquid reservoir such that liquid can be received through the port and stored in the liquid reservoir. A fan assembly is mounted on the front portion of the housing. A spray assembly is provided proximate the fan assembly to dispense liquid from the liquid reservoir of the housing.

### BRIEF DESCRIPTION OF THE DRAWINGS

FIG. 1 is a perspective view of an embodiment of a fan spray device with a character head mounted thereon;

FIG. 2 is a partially exploded perspective view of another embodiment of a fan spray device illustrated with a pair of character heads;

FIG. 3 is a side elevation view of the fan spray device of FIG. 1;

FIG. 4 is a partially exploded side elevation view of the fan spray device of FIG. 1;

FIG. 5 is a bottom end view of the fan spray device of FIG. 1; and

FIG. 6 is a fragmentary perspective view of the fan spray device of FIG. 1.

### DETAILED DESCRIPTION OF EMBODIMENTS OF THE INVENTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

In prior art spray devices having a novelty character head mounted thereon, the character head is mounted directly on a liquid intake port. Placement of the character head on the liquid intake port of the spray device requires a user to dismount the character head to access the liquid intake port and fill the spray device. The required detaching of the character head increases complexity of filling and refilling the fan spray device. The spray device typically has a nozzle that aligns with a mouth area of the character head, which may create difficulty for the user to attach and detach the character head.

For many typical fan spray devices, access to a power source, such as the batteries, is restricted because a fan is added to a spray device as an accessory. Additionally, the height of the fan spray device is typically large because of the axial alignment of the fan, the spray nozzle, and a handle of the fan spray device. The height is also generally large because a fan assembly is merely added to a prefabricated spray device.

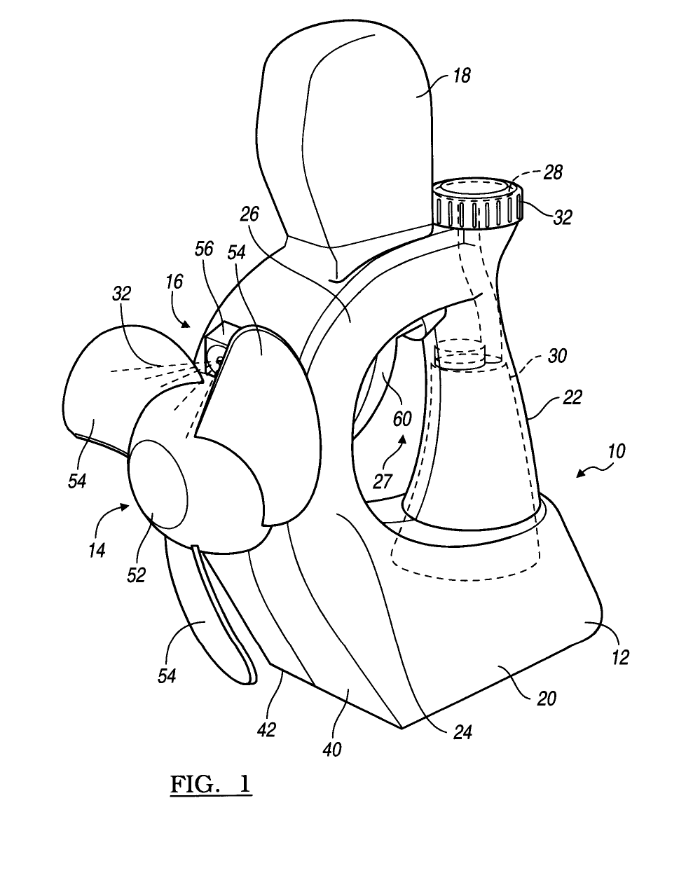

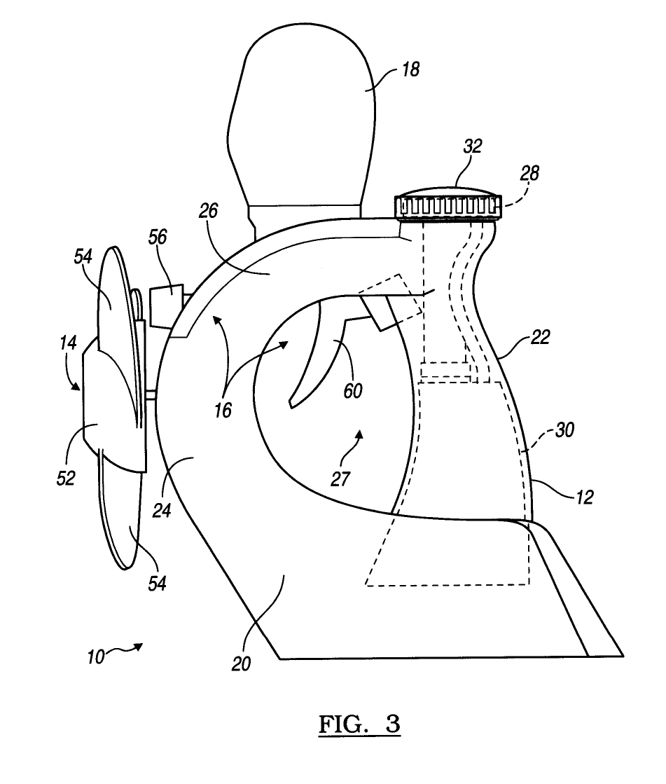

Referring to FIGS. 1-4, a fan spray device is depicted and generally referred to by numeral 10. The fan spray device 10 has a housing 12. The housing 12 is provided to support a fan assembly 14 and a spray assembly 16. In one embodiment, the housing 12 supports a novelty character head 18.

In at least one embodiment, the housing 12 is one, integrally formed component of the fan spray device 10. In another embodiment, the housing 12 is formed of multiple components. As illustrated, the housing 12 has a base portion 20, which is flat to rest upon an underlying support surface. Of course, the base portion 20 may be adapted to rest upon an underlying support surface in any suitable manner. The base portion 20 supports a handle portion 22 and a front portion 24. The handle portion 22 may be ergonomically designed to be sized for a user to grasp. The front portion 24 is spaced apart from the handle portion 22 and supports the fan assembly 14 and the spray assembly 16 so that the handle portion 22 and the fan assembly 14 and spray assembly 16 are not axially aligned to reduce the height of the fan spray device 10. The design of the housing 12 is compact and is dedicated to the combination of the fan assembly 14 and the spray assembly 16.

The housing 12 may have an upper portion 26 located between the handle portion 22 and the front portion 24. The base portion 20, the handle portion 22, the front portion 24, and the upper portion 26 define a trigger aperture 27. In one embodiment, the trigger aperture 27 is sized to receive at least a finger of a user and a portion of the spray assembly 16. In the depicted embodiment, the handle portion 22 is sized to be grasped by an entire hand of the user and the trigger aperture 27 is sized to receive fingers of the hand of the user. Of course, any suitable size and shape of the trigger aperture 27 is contemplated within the scope of the present invention. The illustrated configuration of the housing 12 of the fan spray device 10 is compact and is easy for a user to hold, carry and transport, as opposed to an elongate prior art assembly of an axially stacked bottle, having a spray assembly and a fan assembly.

As illustrated in FIGS. 1-4, the upper portion 26 of the housing 12 supports the character head 18. The character head 18 may have a variety of shapes. For example, the character head 18 may have a shape of an animal character, a cartoon character or any other novelty shape. Of course, any suitable shape for a character head 18, which may be attractive to potential users such as children, is contemplated within the scope of the present invention.

In one embodiment, the character head 18 is integrally formed with the housing 12. In another embodiment, the character head 18 is mounted on the housing 12 after the housing 12 is formed. The character head 18 may be removably mounted on the housing 12 so that the user remove and attach the character head 18. Alternatively, the character head 18 may be permanently mounted on the housing 12. The character head 18 may be mounted to the housing 12 through the use of fasteners or adhesive. Of course, the character head 18 may be removably or permanently mounted to the housing 12 in any suitable manner.

With reference again to FIGS. 1-4, the upper portion 26 of the housing 12 has a port 28 formed therein to receive liquid. The port 28 is connected to a liquid reservoir 30, which is provided within the housing 12 to store liquid and is connected to the spray assembly 16 to provide liquid to the spray assembly 16 upon actuation of the spray assembly 16. In one embodiment, the liquid reservoir 20 is separately formed within the housing 12. In another embodiment, the liquid reservoir 20 is integrally formed within the housing 12. In another embodiment, the liquid reservoir 20 is separately formed and is mounted within the housing 12.

The port 28 is spaced apart from the character head 18 so that the user can fill the liquid reservoir 30 of the fan spray device 10 without removing the character head 18. Since the user does not have to remove the character head 18, filling and refilling of the fan spray device 10 is easier and more convenient than in prior art fan spray devices having character heads.

The liquid reservoir 20 may be provided within the handle portion 22 of the housing 12 so that the fan spray assembly 10 can be compact and have a reduced height compared to known fan spray devices. In another embodiment, the liquid reservoir 30 is provided within the base 20 of the housing 12. In yet another embodiment, the liquid reservoir 30 is provided within the front portion 24 of the house 12. In still another embodiment, the liquid reservoir 30 is provided within the upper portion 26 of the body. The liquid reservoir 30 may be located in two or more portions of the housing 12. Of course, any suitable location within the body 12 for the liquid reservoir 30 is contemplated within the scope of the present invention.

A port cap 32 is mountable on the port 28 so that liquid is sealed within the housing 12 of the fan spray device 10. In one embodiment, the port cap 32 is secured upon the port 28 by a threaded engagement. In another embodiment, the port cap 32 is secured upon the port 28 by applying pressure upon the port cap 32 to snap on the port 28. Of course, the port cap 32 may be secured upon the port 28 in any suitable manner and may be connected to the housing 12 by a tether so that the port cap 32 is not easily lost.

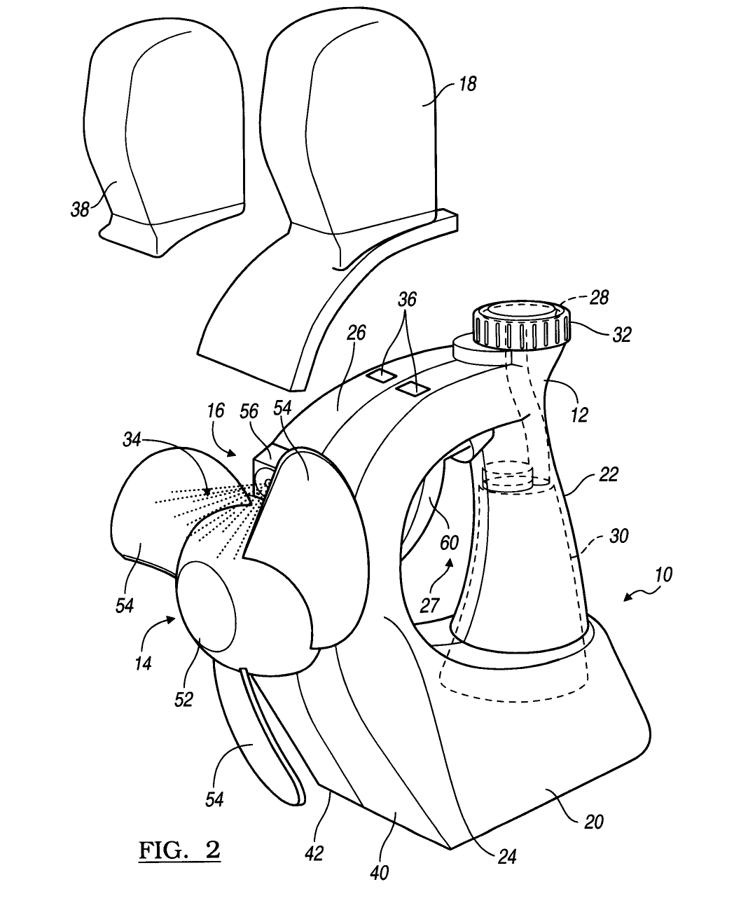

The liquid reservoir 30 is connected to the spray assembly 16 so that when the spray assembly is actuated, liquid is dispensed from the spray assembly 16. As illustrated in FIG. 1, liquid can be dispensed from the spray assembly 16 as a stream 32. As depicted in FIG. 2, liquid can be dispensed from the spray assembly 16 as a mist 34. While the liquid is dispensed from the spray assembly 16, the fan assembly 14 rotates, which forces air movement so that the stream 32 and the mist 34 are entrained in the forced air movement to further cool the user with both the forced air and entrained stream 32 and mist 34.

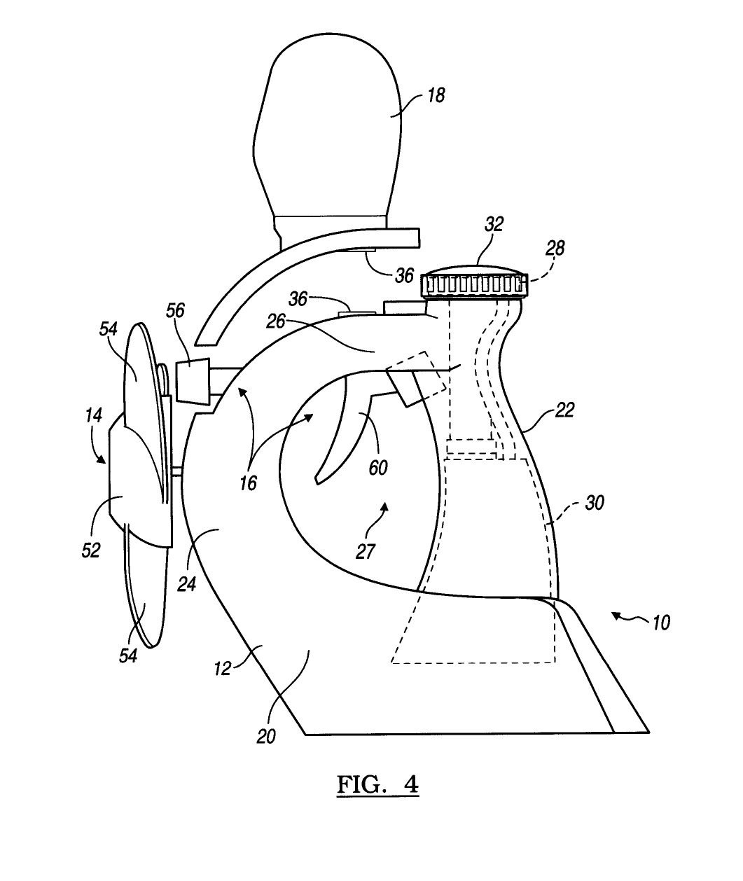

With reference to FIGS. 2 and 4, the character head 18 is depicted detached from the housing 12 of the fan spray device 10. The character head 18 can be conveyed to the user with the fan spray device 10 or can be separately available to the user. The character head 18 may be mounted on the housing 12 with connecting members 36 provided on the upper portion 36 of the housing 12. As seen in FIG. 4, the character head 18 has a corresponding connecting member 36 to mount the character head 18 to the upper portion 26 of the housing 12. The connecting members on the housing 12 and the character head 18 may be corresponding hook and loop fasteners 36, push pins and retention apertures 36, snaps 36 or any other suitable fasteners 36. Of course, any suitable corresponding connecting members 36 on the housing 12 and the character head 18 are contemplated within the scope of the present invention.

Referring now specifically to FIG. 2, a second character head 38 is mountable on the housing 12 of the fan spray device 10. The second character head 38 is interchangeable with the first character head 18 and may have a different shape and/or size from the first character head 18. The second character head 38 may be an entirely different character from the first character head 38, which can be provided to the user with the fan spray device 10 or separately provided to the user. In one embodiment, the second character head 38 has at least one connecting member 36 (as depicted in FIG. 4 with reference to the first character head 18) provided thereon to mount the second character head 38 to the connecting member 36 on the housing 12.

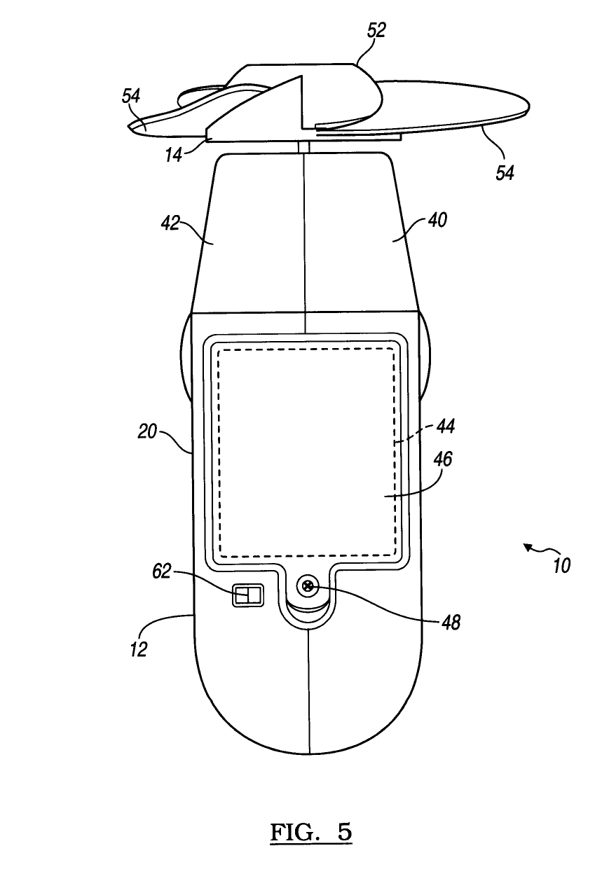

With reference to FIG. 5, the base portion 20 of the housing 12 is depicted with a first housing portion 40 attached to a second housing portion 42, which can be referred to as a clamshell housing 12. The first housing portion 40 and the second housing portion 42 collectively form the housing 12. In another embodiment, the housing 12 has three or more members 40, 42, which collectively form the housing 12. Of course, any suitable amount of members 40, 42 is contemplated within the scope of the present invention.

In the illustrated embodiment, the housing 12 has a battery storage compartment 44 formed in the base portion 20 of the housing 12. The battery storage compartment 44 is sized to receive at least one battery. The battery storage compartment 44 is spaced apart from the fan assembly 14 and is in electrical connection with the fan assembly 14. The location of the battery storage compartment 44 in the base portion 20 allows a user to easily replace the battery when desired. The battery storage compartment 44 has a cover 46 that can be mounted on the battery storage compartment 44 to protect batteries stored therein. The cover 46 may be mounted on the base 20 of the housing 12 with a cover fastener 48. Of course, the cover 46 may be mounted on the base 20 in any suitable manner within the scope of the present invention.

In one embodiment, a switch 62 is provided on or recessed within the base 20 of the housing 12 to actuate the fan assembly 14. The switch 62 is provided within an electrical circuit between the at least one battery provided within the battery storage compartment 44 and the fan assembly 14. The switch 62 can be manually actuated by a user to provide power to the fan assembly 14. The switch 62 can be manually turned off by the user to turn off the fan assembly 14. Of course, any suitable switch 62 to actuate the fan assembly 14 is contemplated within the scope of the present invention.

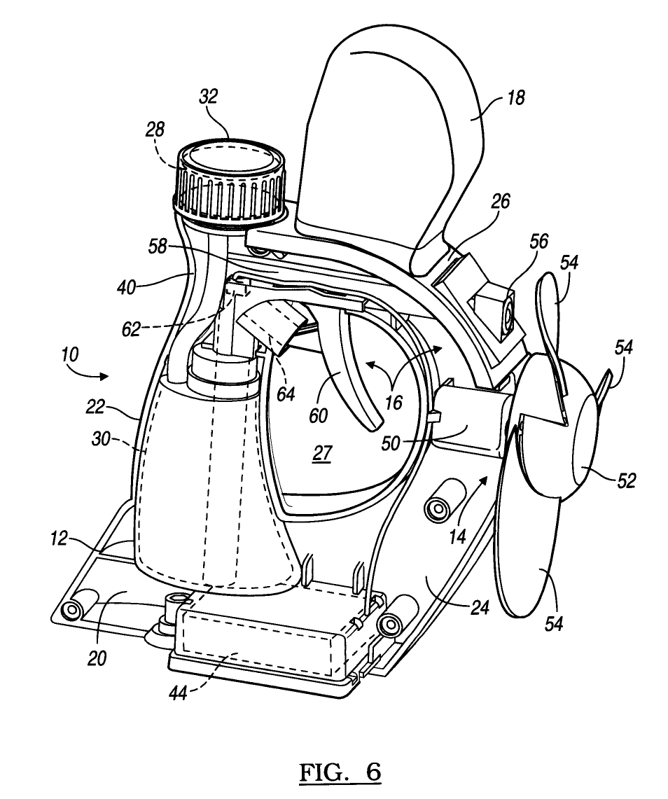

Referring now to FIG. 6, the fan spray device 10 of FIG. 5 is illustrated with the second housing portion 42, of FIG. 5, removed to depict components provided within the housing 10. The character head 18 is shown mounted on the first housing portion 40 and can also be mounted to the second housing portion 42, of FIG. 5.

The fan assembly 14 has a motor 50 that is powered by at least a battery mounted in the battery storage compartment 44. The motor 50 has a rotational output that is connected to a hub 52. Blades 54 are provided on the hub 52. Actuation of the motor 50 causes the hub 52 to rotate the blades 54. The blades 54 provide air movement to cool a user.

In one embodiment, the blades 54 are mounted to the hub 52. In another embodiment, the blades 54 and the hub 52 are integrally formed. Although three blades 54 are illustrated, any suitable amount of blades 54 is contemplated within the scope of the present invention.

As illustrated, the spray assembly 16 has a nozzle 56 provided on the housing 12. The nozzle 56 dispenses liquid from the liquid reservoir 30. The nozzle 56 is connected to the liquid reservoir 30 with a duct 58. Upon actuation of a trigger 60, a pump 64 displaces liquid from the liquid reservoir 30 through the duct 58 so that the liquid is dispensed out of the nozzle 56 via a stream (seen in FIG. 1) or a mist (seen in FIG. 2).

The spray assembly 16 is actuated when a user pivots the trigger 60 generally toward the handle portion 22 of the housing 12. In one embodiment, when the trigger 60 is pulled, the fan assembly 14 is actuated because the trigger 60 causes a switch 62 to complete an electric circuit between a battery provided in the battery storage compartment 44 and the motor 50. The fan assembly 14 may shut off whenever the switch 62 is no longer pulled or displaced by the user. In another embodiment, the fan assembly 14 automatically shuts off after a specified amount of time.

When the fan assembly 14 is driven so that the blades 54 and hub 52 are rotating and liquid is dispensed through the nozzle 56, a user is collectively cooled by the liquid dispensed through the nozzle 56 and air displaced by the blades 54 of the fan assembly 14. In one embodiment, the nozzle 56 is provided proximate the blades 54 of the fan assembly 14 so that as the blades 54 rotate, liquid dispensed from the nozzle 56 is propelled toward the user as a mist so that the user is not directly hit by the liquid as the liquid is dispensed from the nozzle 56.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A fan spray device comprising:
a housing defining a liquid reservoir and a port providing access to the liquid reservoir, the housing having a handle portion;
a fan assembly provided on the housing;
a spray assembly provided proximate the fan assembly to dispense liquid from the liquid reservoir of the housing; and
a character head mounted on the housing and spaced apart from the port such that liquid can be received through the port without removing the character head.

2. The fan spray device of claim 1 wherein the liquid reservoir of the housing is provided within the handle portion of the housing.

3. The fan spray device of claim 1 wherein the spray assembly is spaced apart from the port of the housing.

4. The fan spray device of claim 1 further comprising a port cap that is separate from the spray assembly.

5. The fan spray device of claim 1 further comprising a battery storage compartment provided within the housing spaced apart from the fan assembly and sized to receive at least one battery such that the battery storage compartment is in electrical communication with the fan assembly to power the fan assembly;
wherein the fan assembly further comprises:
a motor in electrical communication with the battery storage compartment and having a rotational output,
a hub connected to the motor to receive the rotational output, and
at least one fan blade provided on the hub.

6. The fan spray device of claim 5 wherein fan assembly further comprises a switch that is actuatable to selectively provide electrical communication between the battery storage compartment and the motor.

7. The fan spray device of claim 1 wherein the fan assembly further comprises at least one blade that is rotatable and the spray assembly further comprises a nozzle for dispensing a fluid stream, such that the nozzle is provided on the housing proximate the at least one blade so that when the at least one blade rotates, the stream of the nozzle intersects with the at least one blade.

8. The fan spray device of claim 1 wherein the housing further comprises a base portion adapted to be supported upon an underlying support surface.

9. The fan spray device of claim 8 wherein the housing further comprises a front portion extending from the base portion to support the fan assembly and the spray assembly.

10. The fan spray device of claim 9 wherein the housing further comprises an upper portion connecting the front portion and the handle portion.

11. The fan spray device of claim 10 wherein the handle portion, base portion, front portion and upper portion define a trigger aperture sized to receive a portion of a trigger of the spray assembly.

12. The fan spray device of claim 1 wherein the spray assembly further comprises:
a duct in fluid communication with the liquid reservoir of the housing;
a pump provided within the housing;
a trigger pivotally connected to the housing to actuate the pump; and
a nozzle in fluid communication with the duct such that when the trigger is pivoted, liquid is pumped from the liquid reservoir through the duct and sprayed out of the nozzle.

13. The fan spray device of claim 12 wherein liquid is sprayed out of the nozzle and entrained by forced air from the fan assembly.

14. The fan spray device of claim 1 wherein the character head is detachable from the housing.

15. The fan spray device of claim 14 wherein the character head is interchangeable with a second character head.

16. A fan spray device comprising:
a housing having a base portion, a handle portion, a front portion extending from the base portion and spaced apart from the handle portion, an upper portion connecting the front portion and the handle portion, and a liquid reservoir disposed only within the handle portion, the upper portion having a port therein in fluid communication with the liquid reservoir such that liquid can be received through the port and stored in the liquid reservoir;
a fan assembly mounted on the front portion of the housing; and
a spray assembly provided proximate the fan assembly to dispense liquid from the liquid reservoir of the housing.

17. The fan spray device of claim 16 further comprising a character head mounted on the housing.

18. The fan spray device of claim 17 wherein the character head is mounted at a distance apart from the port such that liquid can be received through the port without removing the character head.

19. The fan spray device of claim 18 wherein the character head is mounted on the front portion of the housing.

20. A fan spray device comprising:
a housing having a base portion, a handle portion, a front portion extending from the base portion and spaced apart from the handle portion, an upper portion connecting the front portion and the handle portion, and a liquid reservoir disposed within the handle portion, the upper portion having a port therein in fluid communication with the liquid reservoir such that liquid can be received through the port and stored in the liquid reservoir;
a fan assembly mounted on the front portion of the housing;
a spray assembly provided proximate the fan assembly to dispense liquid from the liquid reservoir of the housing; and
a detachable character head mounted on the front portion of the housing and spaced apart from the port such that liquid can be received through the port without removing the character head;
wherein the handle portion, base portion, front portion and upper portion define a trigger aperture sized to a portion of a trigger of the spray assembly.
